(19) United States
(12) Patent Application Publication
(10) Pub. No.: US 2012/0015628 A1
(43) Pub. Date: Jan. 19, 2012

(54) Call Cost Indication Systems And Methods

(76) Inventor: Yogesh Patel, Mountain View, CA (US)

(21) Appl. No.: 13/186,434

(22) Filed: Jul. 19, 2011

Related U.S. Application Data
(60) Provisional application No. 61/365,647, filed on Jul. 19, 2010.

(51) Int. Cl. H04W 4/26

(52) U.S. Cl. 455/406

(57) ABSTRACT

Systems and method provide a call cost indication indicative of a cost of receiving an incoming call by a mobile phone. A cost indication server receives a cost request from a cost requestor prior to setting up the incoming call and retrieves, based upon the cost request, call cost information associated with the mobile phone from a database. The cost indication server then sends the call cost information to the cost requestor. Call rules determine whether the call is intercepted or allowed to proceed based upon one or both of the call cost information and the identity of an initiator of the incoming call.

### RELATED APPLICATIONS

This application claims priority to U.S. Patent Application Ser. No. 61/365,647 filed Jul. 19, 2010, and included herein by reference.

### BACKGROUND

When a caller places a call to a mobile phone, the caller is usually unaware of the location of the called party. While this is generally not a problem, in that the called party carries a mobile phone to allow calls to be received while travelling, he may not wish to receive certain calls, particularly where his mobile phone connects through a service provider that is not his own, and thus calls made or received are considered roaming and incur additional cost.

Telemarketing companies are beginning to target mobile phones for sales calls. However, where a user is roaming, the called party incurs additional charges for incoming calls and may therefore become agitated with the telemarketing company when additional costs are incurred. However, the telemarketing company is not aware of the called party status, and cannot therefore avoid unnecessarily irritating a potential customer.

### SUMMARY

In an embodiment, a cost indication server provides a call cost indication indicative of a cost of receiving an incoming call by a mobile phone to a cost requestor. The server includes a database for storing cost information for receiving the incoming call using the mobile phone, and a request handler for determining the call cost indication based upon the cost information stored in the database and for sending the call cost indication to the cost requestor in response to a cost request prior to connecting the incoming call.

In another embodiment, a method provides a call cost indication indicative of a cost of receiving an incoming call by a mobile phone. A cost indication server receives a cost request from a cost requestor prior to setting up the incoming call and retrieves, based upon the cost request, call cost information associated with the mobile phone from a database. The cost indication server then sends the call cost information to the cost requestor.

In another embodiment, a cost interceptor intercepts an incoming call to a mobile phone. The cost interceptor includes a database for storing information indicating a cost of receiving the incoming call by the mobile phone. The cost interceptor also includes a request handler for receiving a cost request prior to initiation of the incoming call, retrieving the cost of receiving the incoming call by the mobile phone from the database, evaluating one or more call rules that define whether the incoming call is permitted based upon one or both of the retrieved cost and an identity of an initiator of the incoming call, and intercepting the incoming call if the incoming call is not permitted.

### BRIEF DESCRIPTION OF THE FIGURES

FIG. 1 shows one exemplary call cost indication server, in an embodiment.

FIG. 2 shows one exemplary scenario wherein a cost indication server provides call cost information to a service provider making a call to a mobile phone, in an embodiment.

FIG. 3 shows one exemplary cost interceptor for intercepting calls to a mobile phone registered with a mobile phone service provider, in an embodiment.

FIG. 4 is a flowchart illustrating two exemplary processes 400 and 450 that operate concurrently within the cost indication server of FIG. 1

### DETAILED DESCRIPTION OF THE EMBODIMENTS

To prevent raising the ire of a prospective customer, a telemarketing company first determines if the prospective customer is likely to incur additional costs for receiving the call.

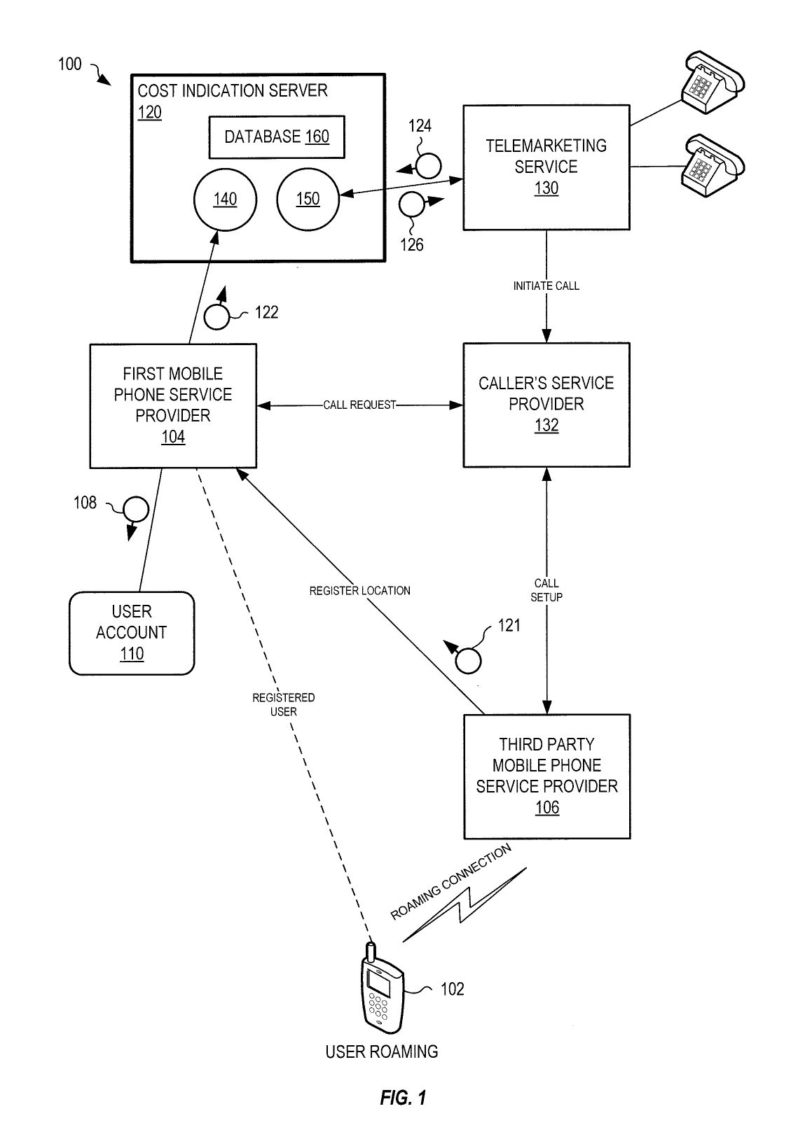

FIG. 1 shows one exemplary call cost indication server 120 within a telecommunication environment 100. Within environment 100, a mobile phone 102 is registered with a first mobile phone service provider 104, but is currently in communication with a third party mobile phone service provider 106 (i.e., not the first mobile phone service provider). For example, the user of mobile phone 102 is travelling abroad and is roaming though a coverage area of third party mobile phone service provider 106 (also referred to hereinafter as “third party provider 106”). When mobile phone 102 connects with third party provider 106, connectivity information 121 is sent from third party provider 106 to first mobile phone service provider 104, since mobile phone 102 is registered within first mobile phone service provider 104, to enable call routing from first mobile phone service provider 104 to mobile phone 102 via third party provider 106.

When a call is routed to mobile phone 102 via third party provider 106, first mobile phone service provider 104 levies a roaming charge 108 to the user's account 110. For example, a contract between the user of mobile phone 102 and first mobile phone service provider 104 defines the cost of roaming calls for mobile phone 102.

Upon receiving connectivity information 121 from third party provider 106, first mobile phone service provider 104 sends incoming call cost information 122, indicating call charges for mobile phone 102 to receive a call based upon current connectivity of mobile phone 102, to cost indication server 120. For example, incoming call cost information 122 is $1 per minute, since mobile phone 102 is roaming via third party provider 106. Incoming call cost information 122 may define a cost rate (e.g., $/minute) rather than a total cost for a call.

Cost indication server 120 is shown connected to first mobile phone service provider 104, but cost indication server 120 may connect to other service provides, such as third party provider 106, without departing from the scope hereof.

Cost indication server 120 includes a call cost receiver 140 that receives incoming call cost information 122 from first mobile phone service provider 104 and a request handler 150 for handling call cost requests 124. Call cost receiver 140 stores incoming call cost information for mobile phone 102 within a database 160. Specifically, incoming call cost information 122 is sent to cost indication server 120 each time connectivity (and more particularly, incoming call cost rate) of mobile phone 102 changes, such as when mobile phone 102 disconnects from services provided by first mobile phone service provider 104 and connects to services of third party provider 106. Current cost of calls to mobile phone 102 is thereby maintained within cost indication server 120.

Incoming call cost information 122 may include a relative, or symbolic, value rather than an actual cost value. For example, incoming call cost information 122 may be defined on a scale of 0-3, where 0 represent no incoming call charges, and the numbers 1-3 represent a scale of roaming charges applied to incoming calls based upon location and connectivity of mobile phone 102 (e.g., charges associated with third party provider 106). Within database 160, cost indication server 120 may utilize a cost scale to represent a current cost of calls to mobile phone 102. For example, within database 160, cost indication server 120 utilizes an integer scale of 0-3, where 0 represents no cost to mobile phone 102 (e.g., free evening and weekend minutes apply and there is no roaming charge), and 3 represents a high cost to mobile phone 102 (e.g., peak minute cost and roaming charges apply).

A telemarketing service 130 sends call cost request 124 for called party cost information (prior to placing a call through their own service provider 132) of a call to mobile phone 102 to cost indication server 120. Telemarketing service 130 subscribes to services of cost indication server 120, for example. Within cost indication server 120, request handler 150 receives call cost request 124 and determines called party cost information 126 from database 160 based upon the call cost request. Request handler 150 then sends the determined called party cost information 126 to the requestor. Information within called party cost information 126 allows telemarketing service 130 to decide whether to make the call to mobile phone 102 based upon costs to the user of mobile phone 102.

In one example of operation, prior to initiating a call to mobile phone 102, telemarketing service 130 sends call cost request 124 to cost indication server 120 requesting the called party costs of a call to mobile phone 102. Based upon current information within database 160 relating to mobile phone 102, cost indication server 120 provides called party cost information 126 to telemarketing service 130.

In an embodiment, the telephone number of mobile phone 102 is included within call cost request 124 to identify mobile phone 102. Similarly, first mobile phone service provider 104 may include the telephone number of mobile phone 102 within incoming call cost information 122. Accordingly, within database 160, mobile phone 102 may be identified by the assigned telephone number of mobile phone 102.

Upon receiving call cost request 124, request handler 150 selects the latest incoming call cost information from within database 160, generates called party cost information 126, and sends it to the requestor. Cost indication server 120 is not limited to receiving requests (e.g., call cost request 124) from telemarketing service 130. Cost indication server 120 may receive requests from other systems without departing from the scope hereof.

In an embodiment, called party cost information 126 may be a relative, or symbolic value, rather than an actual cost value. For example, called party cost information 126 may be defined on a scale of 0-3, where 0 represent no roaming charges and the numbers 1-3 represent a scale of roaming charges based upon location of mobile phone 102 and/or charges associated with third party provider 106. Other codes may be used to indicate incoming call cost information 122 and called party cost information 126 without departing from the scope hereof.

In an embodiment, called party cost information 126 is true or false, indicating whether a call may, or may not, be placed to mobile phone 102. In another example, color codes may be used, such as green for free calls, yellow for normal call costs and red for additional call costs, where free calls occur when the user receives unlimited weekend and evening minutes, yellow indicates the use of regular minutes and red indicates additional roaming charges.

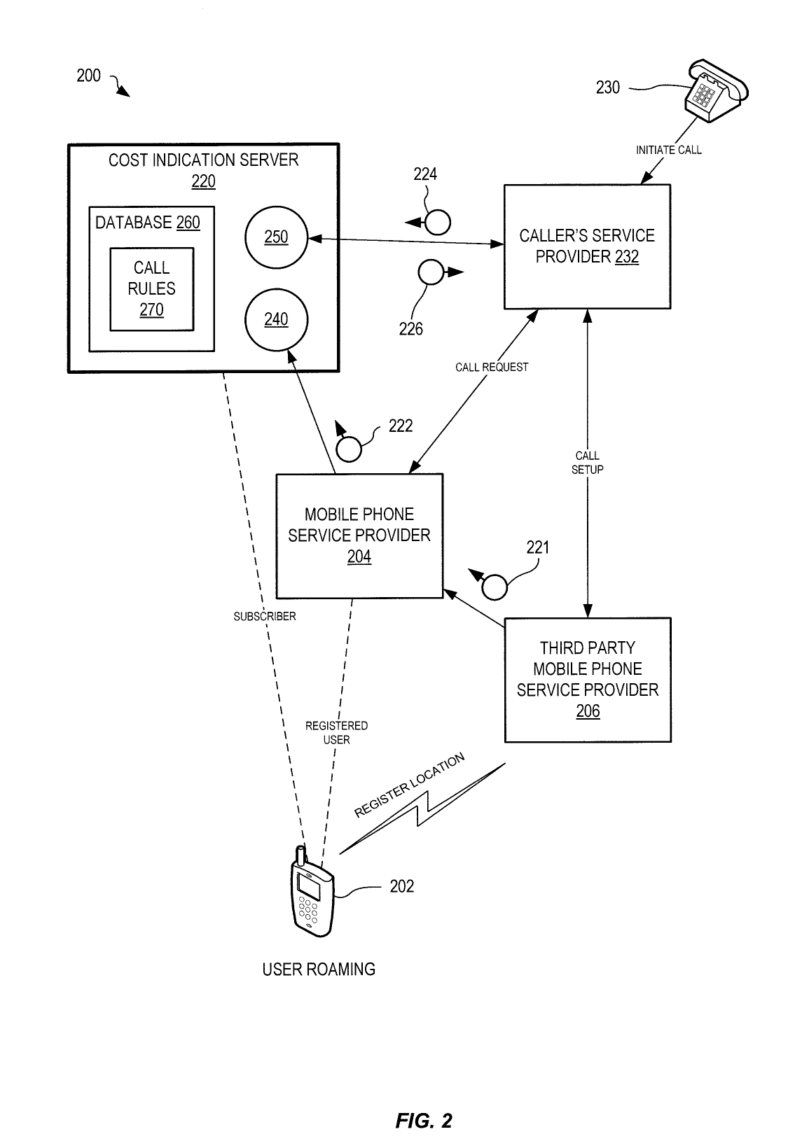

FIG. 2 shows one exemplary cost indication server 220 within a communication environment 200. Cost indication server 220 provides call cost information 226 to a service provider 232 (caller's service provider) placing a call to a mobile phone 202. Cost indication server 220 includes a database 260, a call cost receiver 240, and a request handler 250.

Mobile phone 202 subscribes to services provided by cost indication server 220 and defines call rules 270 that define responses for cost indication server 220 to make to call cost requests for service providers. Call rules 270 define how calls to mobile phone 202 are permitted based upon call costs for mobile phone 202. In one embodiment, identity of mobile phone 202 within cost indication server 220 is based upon the phone number associated with mobile phone 202. Call rules 270 may also utilize the identity of the calling party (e.g., utilizing caller ID information) when determining if cost indication server 220 should permit certain calls. For example, within call rules 270, the user of mobile phone 202 may define one or more numbers from which calls are always accepted. In one example, call rules 270 may define area codes from where (based upon caller ID of the calling party) calls are always permitted, and other area codes where calls are permitted or not based upon current call costs (e.g., roaming status) of mobile phone 202. Call rules 270 are shown stored within database 260 of cost indication server 220, but may be stored elsewhere without departing from the scope hereof.

Call cost receiver 240 receives call cost information 222 from mobile phone service provider 204 defining current call costs of mobile phone 202 based upon connectivity information 221 of mobile phone 202 received from a third party mobile phone service provider 206 (hereinafter “third party provider 206”). For example, where mobile phone 202 connects with mobile phone service provider 204, call cost information 222 may define call costs as “standard”. When mobile phone 202 connects to third party provider 206, for example when roaming, call cost information 222 may indicate “roaming”. Call cost receiver 240 stores call cost information 222 within database 260 in association with the identity of mobile phone 202.

Call cost information 222 may be a relative or symbolic value rather than an actual cost value. For example, call cost information 222 may be defined on a scale of 0-3, where 0 represent no charges, 1 represents standard charges and where the numbers 2 and 3 represent two different levels of roaming charges based upon location of mobile phone 202 and/or charges associated with third party provider 206. Mobile phone service provider 204 automatically sends call cost information 222 to call cost receiver 240 when connectivity or cost status of mobile phone 202 changes. For example, when the user changes connectivity from third party provider 206 (i.e., roaming) back to mobile phone service provider 204 (i.e., not roaming), mobile phone service provider 204 sends call cost information 222 to cost indication server 220.

Request handler 250 receives a call cost request 224 from service provider 232 requesting call cost information relating to mobile phone 202. Request handler 250 retrieves call cost information from database 260 based upon the identity (e.g., the phone number) of mobile phone 202 contained with call cost request 224. Request handler 250 then sends call cost information 226, indicative of call cost information 222, to the requestor, service provider 232. In one example of operation, a calling party 230 initiates a call to mobile phone 202 through their service provider 232. Prior to placing the call to mobile phone 202, service provider 232 sends call cost request 224 to cost indication server 220 and receives in return, call cost information 226 that indicates a cost of the call to mobile phone 202. That is, the cost that would be incurred by mobile phone 202 if the call were placed. In an embodiment, call cost information 226 is indicative of a cost per minute to mobile phone 202 for receiving the call. In an alternate embodiment, call cost information 226 indicates whether the call to mobile phone 202 is permitted based upon the determined cost to mobile phone 202 and defined call rules 270.

Based upon call cost information 226, service provider 232 may or may not attempt to place the call, via mobile phone service provider 204, to mobile phone 202. For example, if call cost information 226 indicates a higher call cost than standard and call rules 270 indicate that the call is at the discretion of the calling party, service provider interrogates calling party 230 as to whether the call should be placed in view of the higher cost to the called party (e.g., the account of mobile phone 202). If the calling party 230 replies that the call is high priority and should be made for example, service provider 232 places the call with mobile phone service provider 204, otherwise the call is not placed. In another example, based upon the ID (e.g., phone number) of calling party 230, current call costs within database 260, and call rules 270, request handler 250 determines that calling party 230 should not be connected when mobile phone 202 is roaming, and sends call cost information 226 indicating that the call should not be made.

Where a call to a user not subscribed to the cost interceptor is made, the mobile phone service provider either (a) does not contact the cost interceptor, or (b) contacts the cost interceptor and receives a non-subscribed or zero cost in response. In an embodiment, calling party 230 receives an audible message requesting confirmation to connect the call when cost indication server 220 responds to call cost request 224 with call cost information 226 indicating a high call cost to mobile phone 202. In another embodiment, the calling party receives a tone and a displayed message requesting confirmation to continue with the call based upon call cost information 226 from cost indication server 220.

In another embodiment, calling party 230 is asked whether they will accept the additional cost of making the call to mobile phone 202, wherein if the calling party accepts the charges, cost indication server 220 instructs service provider 232 to add the additional cost to the account of the calling party.

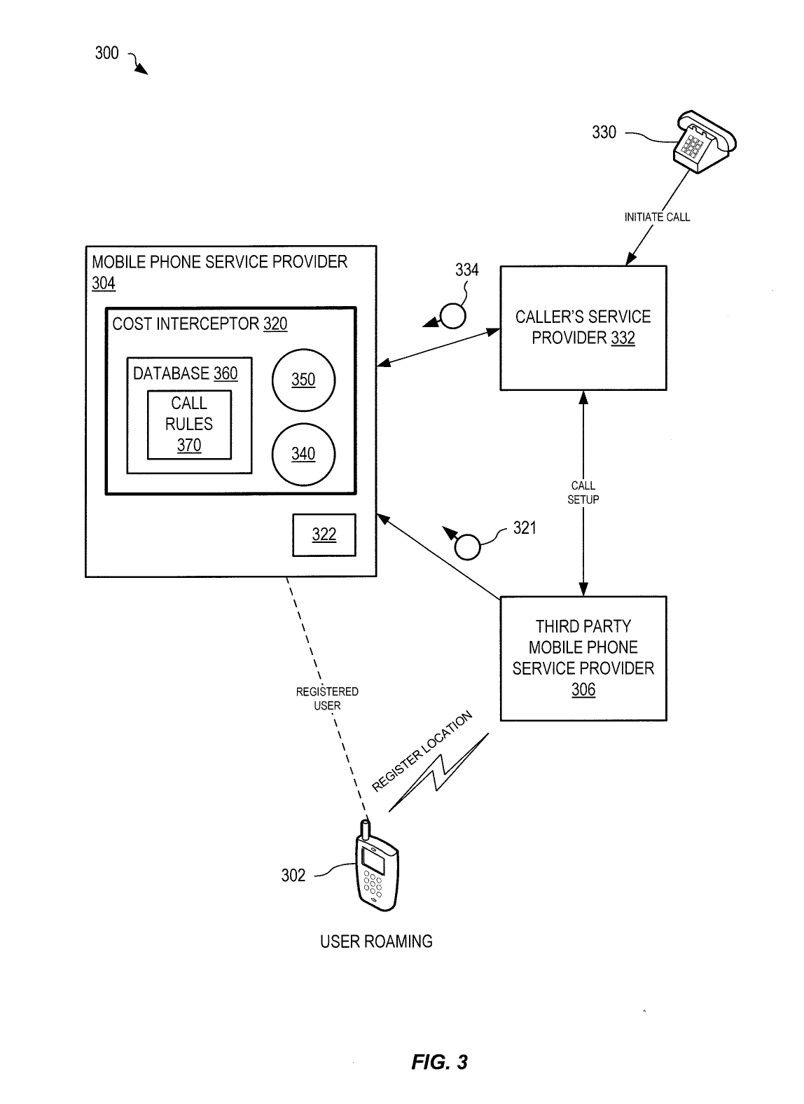

FIG. 3 shows one exemplary cost interceptor 320 within a communication environment 300. Cost interceptor 320 intercepts calls to a mobile phone 302 registered with a mobile phone service provider 304. Cost interceptor 320 is incorporated within (or closely associated with) mobile phone service provider 304 and automatically receives call cost information 322, relating to mobile phone 302, from mobile phone service provider 304. Cost interceptor 320 may include a call cost receiver 340 that receives call cost information 322, generated within mobile phone service provider 304, and stores that information within a database 360. In the example of FIG. 3, mobile phone 302 is connected to a third party mobile phone service provider 306 (i.e., mobile phone 302 is roaming), and call cost information 322 is generated within mobile phone service provider 304 upon receipt of connectivity information 321 from third party mobile phone service provider 306. Call cost receiver 340 stores call cost information 322 within database 360 in association with mobile phone 302.

In one example of operation, calling party 330 initiates a call to mobile phone 302 via a service provider 332, which sends a call request 334 to mobile phone service provider 304. Mobile phone service provider 304 invokes a request handler 350 within cost interceptor 320 to determine whether the call may be connected. Request handler 350 utilizes ID information (e.g., the phone number) of mobile phone 302 included within call request 334 to retrieve current call cost information of mobile phone 302 from database 360. Optionally, database 360 may include call rules 370, for example input by a user of mobile phone 302, that define how calls are handled by mobile phone service provider 304 based upon current connectivity (and thus call cost) of mobile phone 302. For example, call rules 370 may specify that all calls to mobile phone 302 are intercepted from unknown parties when mobile phone 302 is roaming (e.g., connected to third party mobile phone service provider 306). In another example, the user of mobile phone 302 configures call rules 370 to allow all calls no matter the cost, thereby effectively disabling operation of cost interceptor 320 with respect to incoming calls to mobile phone 302.

In an embodiment, where cost information associated with mobile phone 302 retrieved from database 324 indicates additional cost will be incurred by mobile phone 302, cost interceptor 320 may interrogate calling party 330 to ask if the call is urgent and should proceed. For example, cost interceptor 320 (and/or request handler 350) may include voice synthesis and voice recognition capabilities (not shown) to converse with calling party 330. If calling party 330 indicates that the call should proceed, then cost interceptor 320 indicates to mobile phone service provider 304 that the call may continue, wherein the call between calling party 330 and mobile phone 302 may be connected. If calling party 330 indicates that the call is not urgent, or that it should not proceed, cost interceptor 320 does not initiate the call to mobile phone 302, but may connect the calling party 330 to the voicemail service of mobile phone 302, or may disconnect from calling party 330.

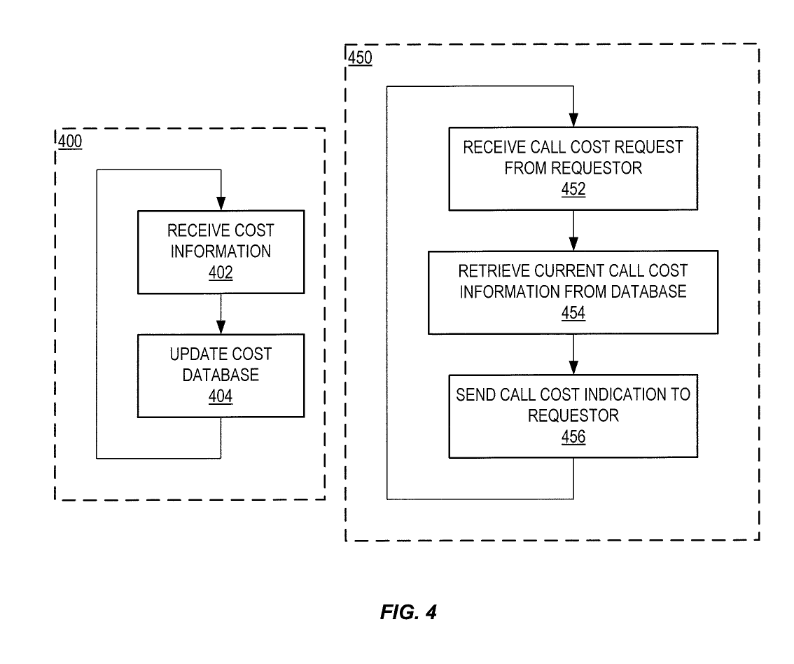

FIG. 4 is a flowchart illustrating two exemplary processes 400 and 450 that operate concurrently within cost indication server 120 of FIG. 1. Process 400 may be implemented within call cost receiver 140, 240 and 340 of FIGS. 1, 2 and 3, respectively. Process 450 may be implemented within request handlers 150, 250 and 350. Processes 400 and 450 may operate concurrently within cost indication server 120, cost indication server 220, and cost interceptor 320.

Process 400 receives, in step 402, cost information (e.g., incoming call cost information 122) from a phone service provider (e.g., first mobile phone service provider 104). Process 400 updates the cost database (e.g., database 160, 260, 360) within step 404, based upon the received cost information of step 402. Steps 402 and 404 repeat within cost indication server 120 to maintain current cost information within database 160 for mobile phone 102.

Process 450, operating concurrently within cost indication server 120, receives a call cost request (e.g., call cost request 124) from a requestor (e.g., telemarketing service 130) in step 452. In one example of step 452, cost indication server 120 receives call cost request 124 that includes a telephone number of mobile phone 102, from telemarketing service 130. In step 454, process 450 retrieves current call cost information from the database. In one example of step 454, cost indication server 120 retrieves current cost information from database 160 based upon the phone number within call cost request 124. In step 456, process 450 sends the call cost indication to the requestor. In one example of step 456, cost indication server 120 sends called party cost information 126 containing an indicator of call costs to mobile phone 102 to telemarketing service 130.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A cost indication server for providing a call cost indication indicative of a cost of receiving an incoming call by a mobile phone to a cost requestor, comprising:
a database for storing cost information for receiving the incoming call using the mobile phone; and
a request handler for determining the call cost indication based upon the cost information stored in the database and for sending the call cost indication to the cost requestor in response to a cost request prior to connecting the incoming call.

2. The server of claim 1, further comprising a cost receiver for receiving the cost information based upon current connectivity of the mobile phone.

3. The server of claim 2, wherein the cost information is received from a mobile phone service provider to which the mobile phone subscribes.

4. The server of claim 2, wherein the cost information is received from a third party mobile phone service provider to which the mobile phone is connected and to which the mobile phone does not subscribe.

5. The server of claim 1, further comprising call rules, stored within the database, defining whether further authorization for the incoming call is required from a calling party initiating the incoming call prior to connecting the incoming call.

6. The server of claim 5, wherein the call rules further define whether the incoming call is permitted based upon an identity of the calling party.

7. A method for providing a call cost indication indicative of a cost of receiving an incoming call by a mobile phone, comprising the steps of:
receiving, within a cost indication server, a cost request from a cost requestor prior to setting up the incoming call;
retrieving, based upon the cost request, call cost information associated with the mobile phone from a database; and
sending the call cost information to the cost requestor.

8. The method of claim 7, wherein the call requestor is a service provider of an initiator of the incoming call.

9. The method of claim 7, wherein the call requestor is a telemarketing service intending to initiate the incoming call.

10. The method of claim 7, further comprising the steps of:
receiving, within the cost indication server, incoming call cost information indicating call charges for the incoming call based upon current connectivity of the mobile phone; and
storing at least part of the incoming call cost information in the database.

11. The method of claim 7, further comprising the step of evaluating one or more call rules defining when the incoming call is permitted based upon the call cost information.

12. The method of claim 11, wherein the call rules further define whether the incoming call is permitted based upon an identity of an initiator of the incoming call.

13. A cost interceptor for intercepting an incoming call to a mobile phone, comprising:
a database for storing information indicating a cost of receiving the incoming call by the mobile phone; and
a request handler for:
receiving a cost request prior to initiation of the incoming call;
retrieving the cost of receiving the incoming call by the mobile phone from the database;
evaluating one or more call rules that define whether the incoming call is permitted based upon one or both of the retrieved cost and an identity of an initiator of the incoming call; and
intercepting the incoming call if the incoming call is not permitted.

14. The server of claim 13, further comprising a cost receiver for receiving cost information indicative of cost of receiving the incoming call by the mobile phone based upon current connectivity of the mobile phone.
